(19) United States
(12) Patent Application Publication
(10) Pub. No.: US 2009/0312005 A1
(43) Pub. Date: Dec. 17, 2009

(54) METHOD AND SYSTEM FOR IMPROVING WIRELESS COMMUNICATION IN TROUBLE SPOTS

(76) Inventors: Purandar MUKUNDAN, Boulder, CO (US); Richard F. DEAN, Lyons, CO (US)

Correspondence Address: QUALCOMM INCORPORATED, 5775 MOREHOUSE DR., SAN DIEGO, CA, 92121, US

(21) Appl. No.: 12/139,898

(22) Filed: Jun. 16, 2008

(51) Int. Cl. H04W 28/22

(52) U.S. Cl. 455/422.1

(57) ABSTRACT

Wireless digital communications involving a mobile device are improved in troublesome locations to prolong a marginal mobile device connections and to avoid dropped calls by proactively improving signal-to-noise ratio. Signal to noise ratio may be increased by reducing the data transmission rate in a variety of ways. Such actions may be taken when current location of a mobile device is in a known troublesome location and/or a characteristic of the signal received by the mobile device is problematic. Similar actions may also be taken to conserve battery power when remaining battery charge drops below a preset criterion.

### FIELD OF THE INVENTION

The present invention relates generally to wireless mobile communication devices and more particularly to methods and systems for improving the reliability of mobile communications.

### BACKGROUND

Usage of wireless mobile communication devices (mobile devices), such as cellular telephones, is ever increasing due to their portability and connectivity. As mobile device usage has increased, user frustration with “dropped calls” has increased. A “dropped call” is the common term for an unexpectedly terminated wireless mobile device call. Areas where users experience a large number of dropped calls are commonly referred to as “dead zones.”

Dropped calls may occur when a mobile device moves out of range of a wireless network during an active call. Mobile devices operate within zones, or cells, each having a geographic coverage area. A base station with a transmitter and receiver located within and serving each cell is controlled such that the effective coverage area of the cell just overlaps with adjacent cells. When mobile devices move within a service provider's wireless network, communication between the mobile device and the network are handed over from base station to base station as the mobile device moves from cell to cell. However, when a mobile device moves outside the range of a service provider's wireless network during an active call, the call will be drop. While the mobile device may have moved into the range of a different service provider's wireless network, an active call cannot usually be maintained across a different service provider's network. Consequently, the active call may be terminated mid-conversation, requiring the user to initiate a new call under a “roaming” situation to continue the voice or data call.

A dropped call may occur when the mobile device is within a service provider's wireless network coverage area, but for some reason interference degrades the signal-to-noise ratio of the received signal to a point where the transmission and receipt of data is unreliable. This may result in garbled or broken voice conversations or the inability to send or receive data. If the signal-to-noise ratio degrades significantly, the call will be dropped as if the mobile device were outside the service provider's wireless network coverage. Signal interference may also prevent the mobile device from entering a roaming mode if the signals of other provider networks are also interfered. Signal interference may be caused by geographic features such as buildings, mountains and hills which block the signal path between the mobile device and the closest wireless network base station. Buildings and geologic features may also reflect signals so mobile devices receive signals along multiple paths which may destructively interfere, causing multipath interference. Signal interference may also be caused by other signal sources located nearby, or other man made interference.

A great amount of money and time is invested by wireless service providers to improve the network quality of service (QOS) to acceptable values. Dropped calls along with congestion are the two most important customer factors that lead to poor customer satisfaction. Despite efforts to increase coverage and reduce the number “dropped calls” by improving the network coverage, dead zones continue to exist.

### SUMMARY

Various embodiment systems and methods improve wireless digital communication involving a mobile device's signal to noise ratio when the mobile device enters a known dead zone to reduce the probability that the call will be dropped. When a mobile device enters a known dead zone the mobile device alters one or more signal characteristics to improve the signal to noise ratio.

Another embodiment includes directly monitoring at least one signal characteristic of the mobile device during an active connection with the network in order to determine whether the mobile device is in a dead zone. If the signal characteristic deviates outside a prescribed range, the data rate may be reduced to improve the signal-to-noise ratio and reduce the error rate, thereby deferring dropping the active connection.

In various embodiments the mobile device may detect troublesome locations and/or problematic signal conditions, and communicate the detected information to the base station. The mobile device and base station may then take proactive steps to improve the signal-to-noise ratio to avoid a dropped call. In various embodiments, the network may detect the troublesome location and/or the problematic signal and proactively take steps to improve the signal-to-noise ratio without initiative from the mobile device. In other embodiments both the mobile device and the network can detect the troublesome location or problematic performance and respond proactively to improve signal to noise ratio and reduce the possibility of a dropped call.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention.

FIG. 1 is a system diagram of a portion of a wireless network system, illustrating a degraded signal-to-noise ratio (SNR) condition due to an interfering object resulting in multipath interference and pilot pollution interference.

FIG. 2A is a graph of the amplitude of several signals reaching a mobile device.

FIG. 2B is a graph of the amplitude of a signal affected by multipath Rayleigh fading.

FIG. 3 is a block diagram of some major components of a typical mobile device.

FIG. 4A is a graph showing a relationship between data rate and signal-to-noise ratio or between data rate and pilot signal amplitude.

FIG. 4B is a layout diagram of three bit sequences sent over a period of T microseconds or 2T microseconds.

FIG. 5 is a process flow diagram of an embodiment method in which a data rate is determined by a mobile device's location.

FIG. 6 is a process flow diagram of another embodiment method in which a data rate is determined by a mobile device's location.

FIG. 7 is a process flow diagram of another embodiment method in which a data rate is determined by a mobile device's location.

FIG. 8 is a process flow diagram of an embodiment method in which a data rate is determined by a characteristic of a received signal.

FIG. 9 is a process flow diagram of another embodiment method in which a data rate is determined by a characteristic of a received signal.

FIG. 10 is a process flow diagram of another embodiment method in which a data rate is determined by a characteristic of a received signal.

FIG. 11 is a process flow diagram of an embodiment method in which a data rate is determined by a mobile device's location and by a characteristic of a received signal.

FIG. 12 is a process flow diagram of another embodiment method in which a data rate is determined by a mobile device's location and by a characteristic of a received signal.

FIG. 13 is a process flow diagram of another embodiment method in which a data rate is determined by a mobile device's location and by a characteristic of a received signal.

FIG. 14 is a process flow diagram of a power save embodiment in which a data rate is determined by the power remaining in the mobile device battery.

FIG. 15 is a process flow diagram of a power save embodiment in which a data rate is determined by the power remaining in the mobile device battery and the location of the mobile device and/or a signal characteristic.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, the term “mobile device” refers to any one of various cellular telephones, personal data assistants (PDA's), palm-top computers, laptop computers with wireless modems, wireless electronic mail receivers (e.g., the Blackberry® and Treo® devices), multimedia Internet enabled cellular telephones (e.g., the iPhone®), and similar personal electronic devices. In a preferred embodiment, the mobile device is a cellular handheld device (e.g., a cellphone), which can communicate via a cellular telephone network. However, cellular telephone communication capability is not necessary in all embodiments. Moreover, wireless data communication may be achieved by the handheld device connecting to a wireless data network (e.g., an IEEE 802.11 “WiFi” wide area network) instead of a cellular telephone network.

As wireless networks coverage has increased in recent years, the use of mobile devices has dramatically increased. Many users no longer find a need to utilize conventional telephones, and instead depend upon mobile devices as their main source of telecommunications. However, one of the top complaints for mobile device users is the problem of “dropped calls.” Mobile devices operate within regions, or cells, each having a geographic coverage area. A base station with a transmitter and receiver located within and serving each cell is controlled such that the effective coverage area of the cell just overlaps with adjacent cells. When the signal strength either received by the mobile device or base station degrades to a certain point the mobile device is no longer capable of sustaining a voice or data call, and a dropped call results. Areas where signal strength persistently is degraded causing a large number of dropped calls are commonly referred to as dead zones or trouble spots.

Given the mobility of mobile device, it is often the case that the mobile device moves into and out of dead zones or trouble spots, such as when a user places a call from a moving vehicle. There are a number of factors that can cause degraded signal strength within a service providers wireless network coverage zone. Physical objects such as mountains, buildings, etc. may block the signal between a mobile device and the base station antenna. Signals from other communication devices operating in the same frequency range may cause interference. Thermal noise resulting from the heating of the Earth and objects throughout the day may cause interference as well.

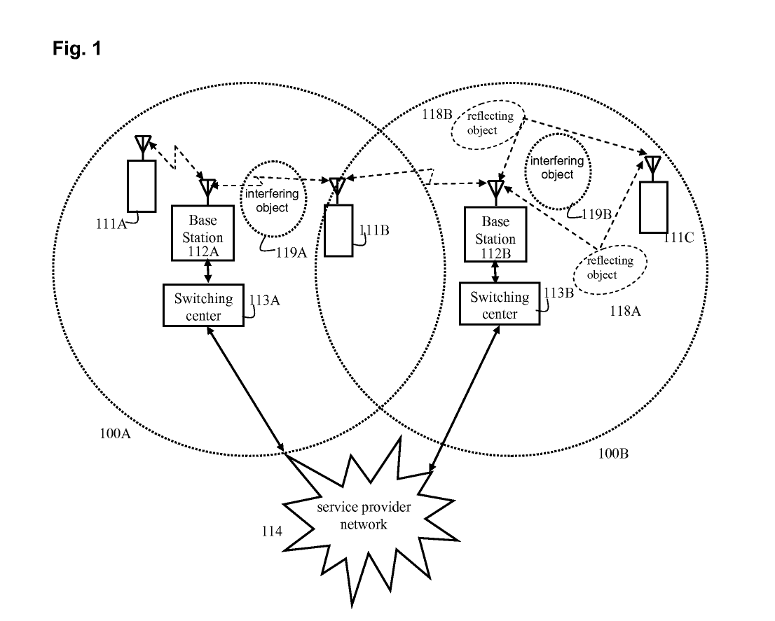

FIG. 1 illustrates a wireless network which typically includes a number of base stations 112A, 112B which communicate with a plurality of mobile devices 111A, 111B, 111C. The base stations 112A and 112B are connected to switching centers 113A and 113Bwhich connect the nodes of the wireless network to the rest of the service provider network 114. Service provider networks 114 may include other base stations and switching centers as well as connections to conventional wired networks (not shown). Each base station includes a transmitter and receiver and is centrally located within a cell. Base stations 112A, 112B are arranged and configured so that the effective coverage area of the cells 100A, 100B just overlaps. Mobile devices 111A, 111B, 111C are intended to operate within a single region or cells at a time.

For example, mobile device 111A is shown as being located well within cell 100A which is serviced by base stations 112A and switching center 113A. As shown in FIG. 1, the mobile device 111A transmits and receives communication signals from base station 112A with no degradation of signal as the signal path is unobstructed.

However, other mobile devices 111B may have their signal path to the nearest base station 112A obstructed by an interfering object 119A. An interfering object 119A may partially block the line-of-sight signal path between the base station 112A and the mobile device 111B, and thus cause marginal, attenuated communication service in either or both directions. The interfering object 119A, for example, may be an intervening building or a hill. Instead of an interfering object 119A, troublesome communication service may simply result from the distance between the base station 112A and the mobile device 111B.

If a mobile device initiates a call in the clear such as at the position of mobile device 111A but moves to the position of mobile device 111B where an interfering object 119A partially blocks the communication signal, the signal-to-noise ratio may degrade to the point where the call is dropped. For CDMA networks specifically, the call may be dropped when a signal amplitude deviates below about −100 dBm (including all of the 1.25 MHz spread spectrum), because of the typical amplitude of thermal noise.

A cellular communication connection may be determined to be marginal when a rate of detected errors deviates outside a prescribed range. The error rate generally is directly related to the signal-to-noise ratio (SNR), which may be low because of a weak signal, excess noise, or both. The error rate may be measured either in the forward direction by the mobile device 111 or in the reverse direction by the base station 112.

Another possible cause of a troublesome communication is multipath interference. As also shown in FIG. 1, an interfering object 119A (e.g., a building or a hill) may be blocking the line-of-sight signal path between the base station 112B and the mobile device 111C. Reflective objects 118A, 118B may furnish multiple indirect signal paths causing mutually cancelling multi-path interference, resulting in marginal communication service for mobile device 111C. The reflecting objects 118A, 118B, for example, may be radio wave reflectors such as water tanks or the steel framework of buildings. Also, a signal may refract around an interfering object 119B following at least two different paths of different length. If portions of the signal traveling the multiple paths are out-of-phase with each other there may be destructive interference. That is, the portions of the signal fully or partly cancel each other locally in specific locations reducing the power of the received signal. In such specific locations (which are separated by one-half wavelength), the received signal may be weak compared to nearby locations. Because the noise level may not be weak while the received signal is weak, the result is a low SNR.

Another cause of troublesome communication is referred to as pilot pollution interference in CDMA technology communications, and as a dominant server problem in other communication technologies. With reference to FIG. 1, a mobile device 11B may be geographically situated so that it receives pilot signals of relatively similar amplitude from more than one base station 112A and 112B. Too many pilot signals can interfere the mobile device 111B communication and may cause a network connection to be dropped. In such cases, the SNR may be low because the excess pilot signals in effect appear as increased noise, even though the received data signal amplitude may otherwise be adequate.

The various technologies supporting wireless communications (e.g., GSM, CDMA, W-CDMA, CDMA2000, UMTS, Wi-Fi, Bluetooth, Zigbee, etc.) each have limitations that can cause problems, some common and some unique to a particular technology. One of skill in the art will appreciate how the various embodiments disclosed herein may be applied to the variety of wireless communication technologies. For illustrative purposes only, many of the embodiments disclosed herein are discussed in a CDMA context, but can easily be adapted to other wireless communication technologies.

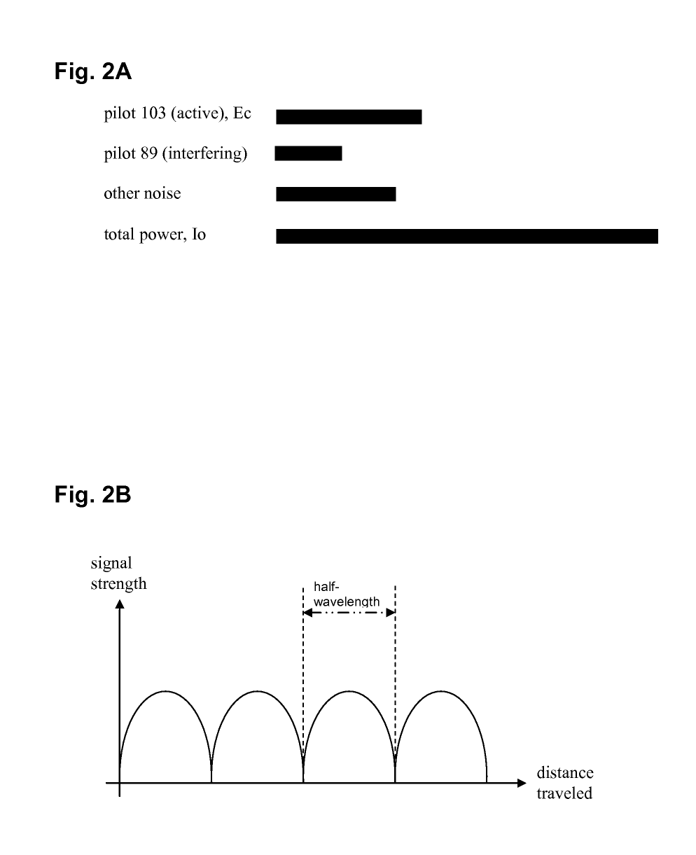

FIG. 2A is a graph of the power of several signals reaching a mobile device 11 B. The signals may include an active pilot signal (with index 103) from a primary base station 112B as well as other interfering pilot signals (with index 89). Too many received pilot signals from adjoining cells—a situation referred to as pilot pollution—may appear as noise. In addition, there will be some amount of thermal noise and other noise from unrelated electromagnetic radiation sources. The signal-to-noise ratio, SNR, may be approximated by the ratio Ec/I₀, where Ec is the power of the active pilot signal as measured by the receiver 195 of the mobile device 111B, and where I₀ is the total received power. Alternatively, the SNR may be approximated by Ec/(I₀-Ec). The ratio may be represented logarithmically by decibels, dB, as is customary in the art of radio communication. For cdma200 based communication, troublesome reception may begin to develop when Ec/I₀ deviates below about −13 to −15 dB. For W-CDMA based communication, troublesome reception may begin at and below about −18 dB.

FIG. 2B is a graph of the amplitude of a signal showing the affects of multipath Rayleigh fading as a mobile device travels from one location to another. Portions of a signal may travel different paths and have comparable strengths, as discussed above with reference to FIG. 1. In some locations the portions of the signal are in-phase and constructively interfere, resulting in a strong signal. In locations located only a half-wavelength away portions of the signal may be out-of-phase and at least partially cancel each other, resulting in at best a weak signal. If the mobile device 111C is statically positioned at an out-of-phase location, a communication connection can be marginal, because the signal is low with respect to the noise, which may not be affected by Rayleigh fading. That is, the SNR is low. If the mobile device 11C is in motion, the signal can flutter in strength-alternatively strong and weak. Such a marginal connection may cause the base station 112B to drop the current active connection to a mobile device 111C.

The various embodiments attempt to mitigate the impact of interference and dead zones in order to avoid dropping calls. By knowing or detecting when the mobile device is about to move into these dead zones or trouble spots, proactive steps may be taken by the mobile device and/or base station to improve the signal to noise ratio so that a dropped call is prevented and call quality is maintained.

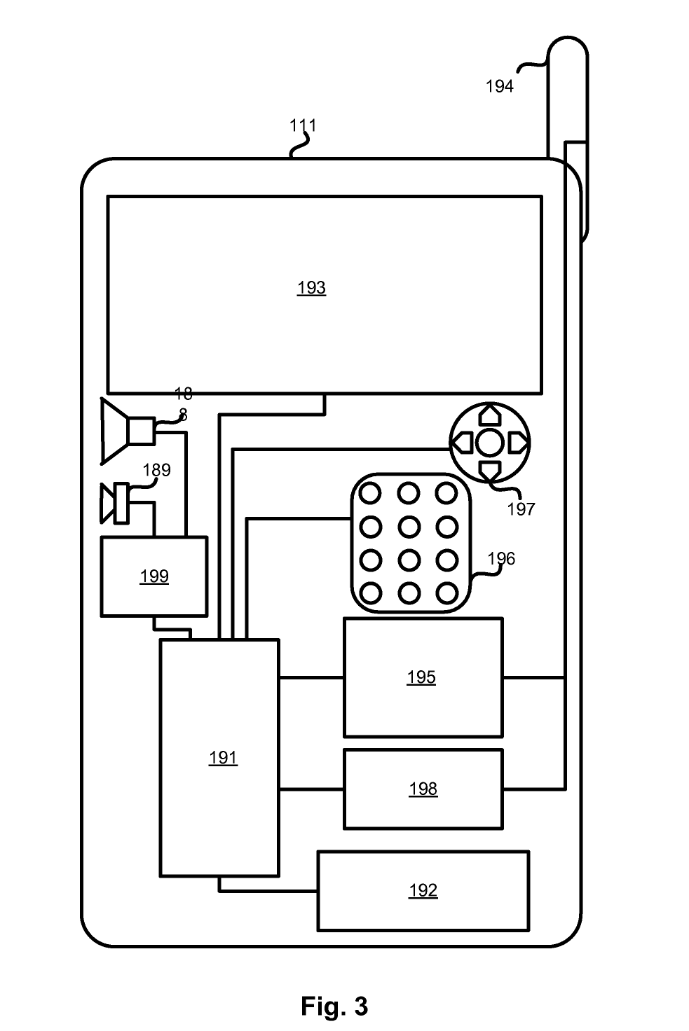

FIG. 3 depicts various components of a mobile device 111. As shown in FIG. 3, a mobile device 111 may include microprocessor 191, a memory 192, an antenna 194, a display 193, a numeric keypad 196, a 4-way menu selector 197, a speaker 188, a microphone 189, a vocoder 199, a receiver 195, a transmitter 198, and various interconnections. In particular, the receiver 195 receives digital voice or data, signaling channel data, as well as one or more pilot signals. The receiver 195 receives signaling channel data through which the network may control various communication transmission signal characteristics. These communication signal characteristics may include, for example, the digital data rate of the outgoing signal, the error encoding scheming and level of interleaving, as well as the output power of the transmitter 198. Furthermore, the receiver 195 may supply to the microprocessor 191 with various communication received signal characteristics. These may also include measurements of the total received signal power I₀, the digital data rate of the incoming signal, the error encoding scheming and level of interleaving, and/or the pilot signal power Ec.

In an embodiment, the microprocessor 191 may generate status information to be transmitted through the transmitter 198. The status information may include an indication or a request to decrease or increase the data rate of the transmitted data. A change in the data rate may change the compression rate of the vocoder 199.

In order to prevent dropped calls, an embodiment method detects when the mobile device 111 is physically in or is about to enter a dead zone. The embodiment method then takes proactive measures to increase the SNR in order to maintain the call quality and prevent the occurrence of a dropped call. While the simplest measure to simply increase the power of the communication signal to boost the SNR, battery power constraints as well health and safety constraints limit the amount that signal power can be increased. Accordingly, the various embodiments disclosed herein employ various methods to improve SNR when output power is already at or near maximum levels. While an absolute maximum transmitted/received signal power level is imposed on mobile devices for health and safety reasons, mobile devices are configured and operated as part of a mobile communication system to use the minimum transmission power that supports an acceptable SNR. Thus, in areas of average to good communication conditions, the mobile device 111 operating in conjunction with the base station 112 will reduce transmission power well below the allowable maximum, minimizing transmission power extends battery life. As communication conditions worsen, the mobile device 111 operating in conjunction with the base station 112 will increase transmission power to maintain SNR. However, if communication conditions are too bad, transmission power will be increased to the maximum power level. When transmission power is set at the maximum value, it is not possible to improve SNR by further raising power. The various embodiments disclosed herein proactively alter various signal characteristics in an attempt to improve SNR when transmission power is limited to the maximum allowable output power level. While such measures may be implemented only once transmission power reaches maximum limits, the measures may also be taken when transmission power is below the maximum level, such as in anticipation of entry into a known dead zone where transmission power will be raised to maximum. Also, if such measures are implemented when transmission power is at maximum, they may not be reversed before transmission power is reduced below the maximum level. For example, the mobile device 111 may continue to use a reduced data transmission rate for a period of time after transmission power is lowered below maximum to ensure the communication characteristics are not changed while the mobile device is still in a troublesome area.

In one embodiment a method proactively reduces the rate at which data is transmitted and received. By reducing the data rate a call may be maintained with an improved SNR with some degradation of voice quality. For example, by halving the date rate, a 3 dB boost in SNR may be expected. For voice calls the normal voice data rate is 8 kb/s. While slower data rates for voice calls may be acceptable, data rates much slower may cause noticeable degradation in quality and result in frustration by the user in the voice call. Data calls provide more flexibility in reducing data rates. Data rates for data calls may be reduced to as low as 1200 b/s.

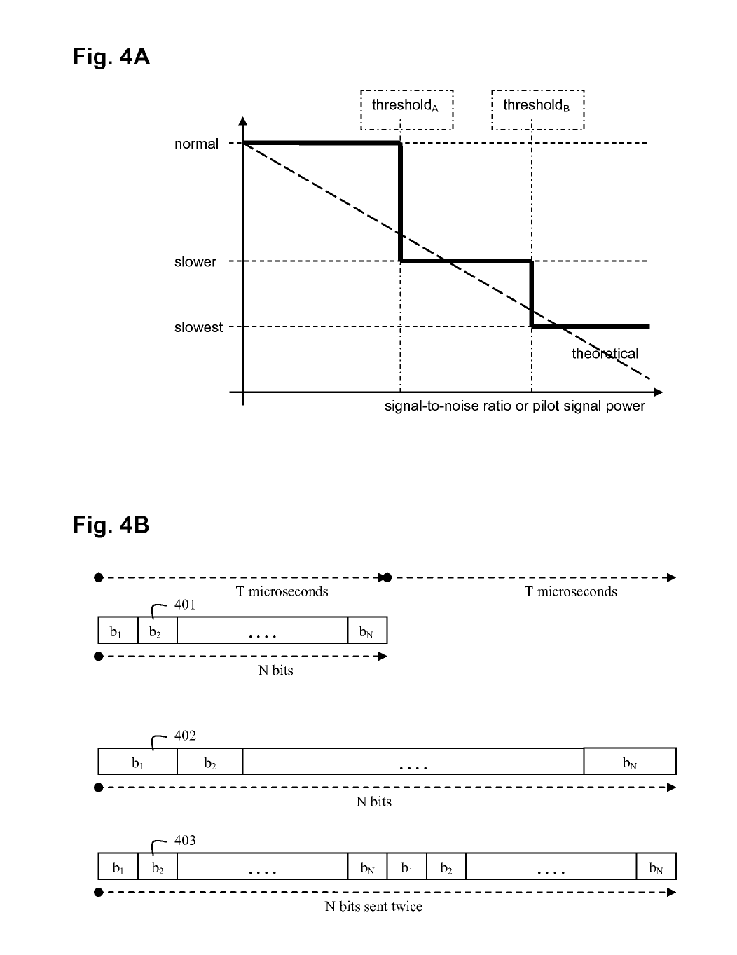

FIG. 4A is a graph showing a theoretical relationship between data rates and the corresponding signal-to-noise ratios for the data rates. Instead of signal-to-noise ratio, the horizontal axis may alternatively represent a signal's amplitude-assuming that the noise component of the SNR has a constant amplitude on average and is independent of the data rate. It is well known in communication theory that a signal's SNR is inversely related to the signal's data rate in general when all other factors are the same. This relationship between a signal's SNR and the signal's data rate can be utilized to help defer or prevent dropping a problematic active connection by reducing the data rate of a mobile device 111, thereby increasing the SNR and reducing the error rate. Because it may be impractical to continuously vary the data rate of a mobile device 111, the theoretical relationship may be approximated by several data rates in a stepwise manner. The data rate may be reduced to a lower value any time the SNR deviates outside a prescribed range. The range may be defined by one or more thresholds, such as Threshold_{A} and Threshold_{B}.

Thus, in one embodiment when the mobile device 111 is detected to enter a dead zone, the microprocessor 191 can direct the transmitter 198 to reduce the data rate at which the mobile device 111 communicates. In addition, the microprocessor 191 may generate a signal for transmission to the base station 112 to instruct the base station to reduce the transmitted data rate as well so that the SNR of signals received by the mobile device 11 receiver 195 is improved as well. By improving the SNR, a dropped call may be avoided despite the fact that the mobile device 111 is located in a dead zone.

There are a number of ways that the data rate can be reduced in order to increase SNR. One method is simply to send fewer bits per second with the encoding of each bit spanning a longer duration. Another method for reducing the data rate is to send the same data two or more times. These methods are illustrated in FIG. 4B which shows three N-bit sequences.

In the normal transmission case illustrated in the first sequence, a sequence 401 of N bits is sent during T microseconds. In FIG. 4B, the encoding of the i^{th} bit is represented by the transmitted signal bᵢ for i=1, . . . , N. Increasing the duration of each bit is illustrated in the second sequence in which a single sequence 402 of N bits is transmitted during the time of 2T microseconds, where each bit bᵢ is represented by a signal transmitted for twice as long. With more signal time per bit, the integral of the signal over the bit duration increases compared to the noise, thereby increasing SNR. The sequence 402 cuts the data rate in half and requires only half the bandwidth of the sequence 401 of N bits, but the sequence 402 has an higher SNR.

Another way to transmit the N bits during the 2T microseconds is to send the sequence 403 twice at the original data rate. Sending the N bits twice produces an effective data rate that is half the normal data rate. Using a sequence 403 of repetitions of N-bit subsequences may avoid changing hardware data rate clocks but requires further processing in the receiver. Maintaining the same data rate but repeatedly sending the N-bits subsequences may be particularly applicable for transmissions from a base station 112 communicating with multiple mobile devices 111A, 111B, etc. using synchronized data rates. When the sequence 403 is received, each corresponding bit bᵢ of each subsequence may be combined by averaging together each of the two signal amplitude occurrences encoding an original bit to reconstruct the single N-bit sequence. If the averaged signal amplitude representing a bit neither represents a 0 or a 1 distinctly, then the sequence 403 may be treated as an error. Although the CDMA air interface for encoding, transmitting, receiving, and decoding such an N-bit sequence is quite complex, the principle of increasing SNR by reducing data rate still holds.

A third method for decreasing the data rate to increase SNR involves increasing the amount of error correction and noise compensation encoding implemented within the signal. Error correction coding involves sending additional information within the bit stream to enable the receiver to recognize and correct an error in received data. One method for accommodating noise and fading is data interleaving in which bits from multiple message elements (sequences of multiple bytes) are intermixed so that the bits of any one message element are transmitted at different times across the span of a few milliseconds. In this manner, a fade that blocks a few bits in a transmission, will only block a single bit in any one message element. When combined with error correction coding, a receiver can then correct for the error caused be a lost bit in any one message element. The additional data associated with the error correction codes and interleaving reduces the data transmission rate and reduces the bit error rate.

Of course, the foregoing methods may be combined to provide even greater SNR performance at the expense of data transmission rate. For example, the bit duration can be increased, data can be transmitted multiple times, and error correction encoding with data interleaving may be implemented or the coding rate can be changed.

The systems and methods described herein may be especially applicable to the reverse signal (from the mobile device 111 to the base station 112), but may also be applied to the forward signal (from a base station 112 to a mobile device 111). Changing the data rate in the forward direction may need to be implemented in a way that does not affect other mobile devices 111 actively communicating with the same base station 112.

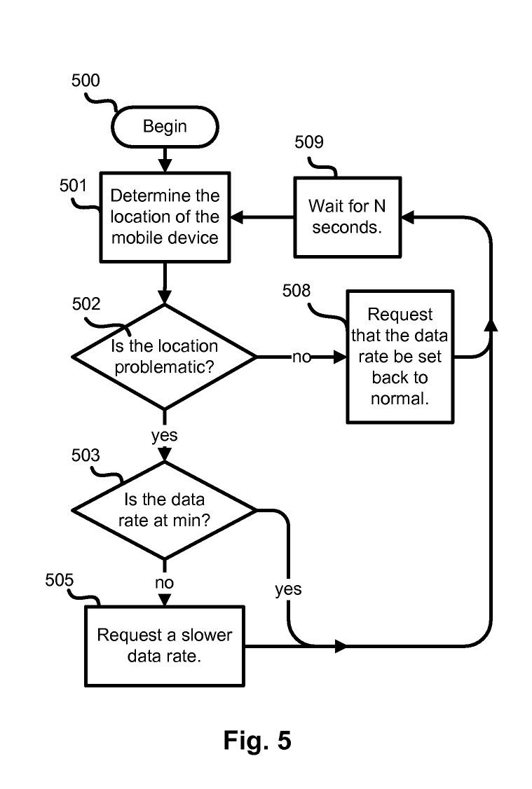

An embodiment for proactively compensating for a dead zone is illustrated in FIG. 5 which shows a process 500 for implemented on a mobile device 111 to adjust its data transmission rate based on its location. The process 500 begins by determining the location of the mobile device 111, step 501, which may be accomplished by the mobile device 111 using a variety of methods. For example, an embodiment may utilize GPS (Global Positioning System) coordinate information if the mobile device 100 has a built-in GPS receiver. In such an embodiment, the mobile device 111 may utilize A-GPS (Assisted GPS), in which the determination of the global position of the mobile device 111 is aided by the base station 112 informing the mobile device 111 of the GPS satellites that are currently in view. In instances where the mobile device 111 does not have a built in GPS receiver, an embodiment may employ AFLT triangulation, which estimates the location mobile device 111 using the phase relationship of multiple pilot signals from three or more base stations 112A, 112B, 112C, etc. which are at known locations. Other known methods of estimating the location of the mobile device 111 may be used.

The process 500 continues by determining whether the determined location is known to be troublesome or a dead zone, step 502. A variety of methods may be employed to make this determination. For example, a database of known troublesome locations may be stored in memory 192 within the mobile device 111. When the current location of the mobile device 111 is determined in step 501, the coordinates may be compared against the known troublesome locations stored in memory 192 to determine if there is a match. Alternatively, the database of known troublesome locations may be stored in a database memory located in the switching center 113 or base stations 112. In this embodiment, the mobile device 111 may transmit its location to the base station 112 or switching center 113 which may in turn inform the mobile device 111 if its current location is troublesome. In a third embodiment, the database of troublesome locations stored on the mobile device 111 may be updated periodically by the service provider network 114 and may be tailored to provide an up to date list of known troublesome locations within wireless coverage cells in which the mobile device 111 has historically operated.

If the mobile device 111 location is known to be troublesome, the process 500 determines whether the effective data rate is already at a specified minimum value, step 503. The effective data rate may already be at a specified minimum value if the mobile device 111 was previously determined to be in a troublesome location. For voice transmissions, the minimum effective data rate may be the vocoder sampling rate could be one of several available compression rates, and the lower rates may result in an audible distortions that may impact a user's experience. The minimum data rate for non-voice data can be lower, however, such as low as 1200 bits per second. If the data rate is not already at the minimum value, then the mobile device 111 requests that data rate be reduced in order to boost the effective SNR, step 505. This request needs to be made to the base station 112 so the base station is informed of the data rate (and associated encoding) that it must receive and should use in transmitting to the mobile device 111. Then the mobile device 111 and the base station 112 begin using the reduced data rate (and associated encoding) at a coordinated time.

In an alternative embodiment, the service provider network 114, not the mobile device 111, determines the minimum data rate and informs the mobile device 111 of the data rate (and associated encoding) to will be used. For example, the base station 112 may direct the mobile device 111 to use a slower data rate that is one-half of the normal data rate. As another example, in CDMA communications, the data rate is controlled by the base station 112, not by the mobile device 111. The base station 112 can establish a new data rate by sending a message to the mobile device 111 using the CDMA signaling channel. The base station 112 may set a reduced data rate on its own initiative (such as upon determining that the mobile device 111 is about to enter a troublesome location), or in response to a request from the mobile device 111. A request for a slower data rate is not part of the CDMA standard specification, so new standardized or proprietary code for this request may be required to implement this embodiment.

As it continues to move, the mobile device 111 may pass into and out of troublesome locations. As the mobile device 111 moves out of troublesome locations, it is desirable to increase the data rate commensurate with improvements in the communication link and SNR. In this way, the call quality can be optimized when the conditions permit. Accordingly, after a brief period of time the process 500 repeats, allowing changes to be made the data rate indefinitely or until the active connection. By repeating the process, data rate can be adjusted consistent with the communication conditions of the new location of the mobile device 111. If the mobile device 111 moves out of the troublesome spot or dead zone, the process 500 will determine that the mobile device 111 is no longer in a troublesome location, and request that the data rate be reset back to the normal data rate, step 508. After waiting for a period of time to pass, such as N seconds, the system may repeat the process flow as the mobile device continues to change locations, step 509.

The forgoing method may be implemented as software operating on a processor in the mobile device 111, in a network processor, such as in the base station 112 or switching center, or implemented across the system with some steps implemented on a processor within the mobile device 111 and some steps implemented on a processor within the network.

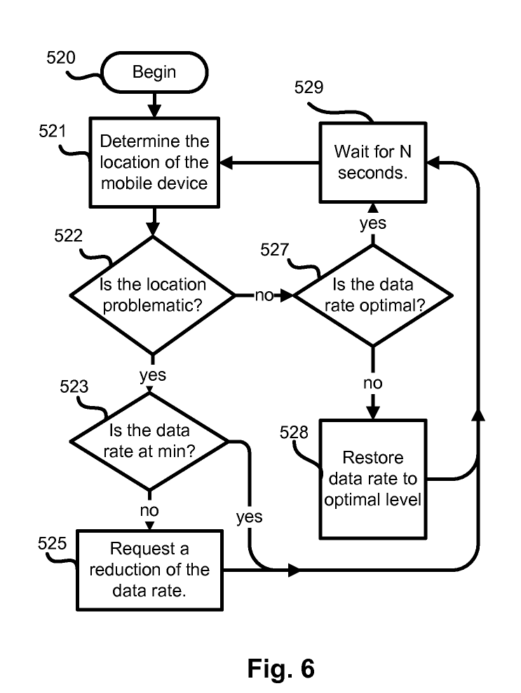

In an alternative embodiment illustrated in FIG. 6, multiple data rates are used to more closely match data rates to the data carrying capacity of the communication link. This process 520 begins by determining the location of the mobile device 111, step 521. Determining the location may be accomplished using any of the methods described above with reference to FIG. 5. The process 520 continues by determining whether the location is known to be troublesome, step 522 using any of the methods described above with reference to FIG. 5. If the location is known to be troublesome, the process 520 determines whether the effective data rate is already at a specified minimum value, step 523. If not, a request is sent from the mobile device 111 to the base station 112 to decrease the data rate. Alternatively, the mobile device 111 may send a request to decrease the data rate without checking to see if the current data rate is at a specified minimum. If the current data rate is already at the minimum, the request may simply be ignored. Otherwise, the base station 112 may respond by directing the mobile device 111 to use a data rate that is one-half of the current data rate, for example, where the current data rate may already be slower than the normal data rate. For example, each reduction in data rate may be one half of the previous data rate, where there are a fixed number of supported data rates.

Whether or not the mobile device 111 requested a slower data rate, the process 520 continues by waiting for a brief period of time, such as a few seconds, step 529 before repeating by returning to step 521. The process 520 continues indefinitely or until the active connection with the mobile device 111 is terminated.

If the process 520 determined that the location of the mobile device is not known to be troublesome (i.e., step 522=“no”), then the process 520 tests whether the data rate is at its optimal level, step 527. If not, the process 520 may request that the data rate be restored to the optimal data rate, step 528. Thereafter, the process 520 waits for a brief period of time, step 529, before repeating by returning to step 521. Thus, the data rate can be ratcheted up or down in response to changes in the SNR. The new data rate may apply to either or both of the forward and reverse signals, because if the reception of the forward signal by the mobile device 111 is problematic, then in most cases the reception of the reverse signal from the mobile device 111 will also be problematic.

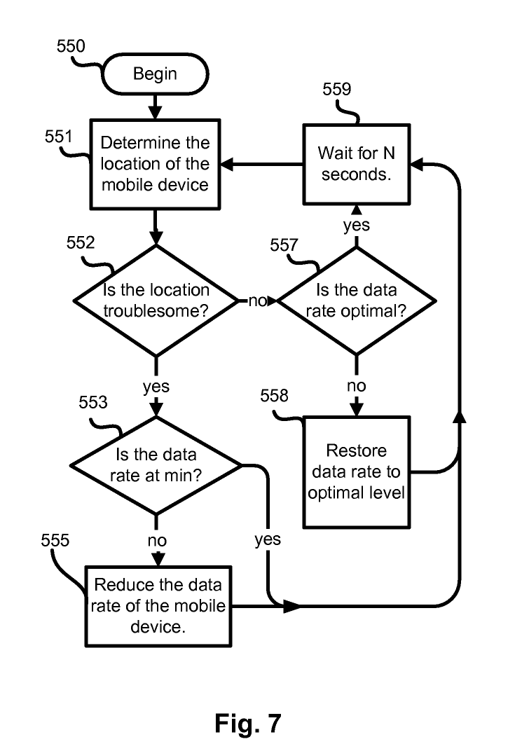

The processes 500, 520 described with reference to FIGS. 5 and 6 may be executed primarily on the mobile device 111, with the base station 112 determining whether the data rate should be reduced or increased. In another embodiment illustrated in FIG. 7, the process 550 may be executed by a processor in a switching center to which a mobile device 111 is linked. This embodiment process 550 begins by determining the location of the mobile device 111, step 551. The base station 112 may request the mobile device to report its location, which may be determined by the mobile device 111 using any of the methods described above with reference to FIG. 5. Alternatively, mobile devices 111 (particularly those equipped with GPS receivers) may periodically report their positions to base stations 111 as part of normal link management communications.

The location of mobile device 111 is compared to locations known to be troublesome, step 552 to determine if the mobile device 111 is approaching or in such a location. For example, the base station 112 may maintain a database of troublesome locations. If the location of mobile device 111 is within a given radius of one of the locations in the database and if the mobile device 111 is already transmitting at maximum power, then the location of the mobile device may be deemed troublesome. In that case, the process 550 determines whether the data rate is already at a specified minimum data rate, step 553. If not, the base station 112 may reduce the data rate by sending to the mobile device 111 a new data rate using the CDMA signaling channel, step 555. For example, the data rate may be set to one-half the current data rate. Whether or not the data rate was reduced, the process 550 continues by waiting for a brief period, step 559, before repeating.

If the current location of the mobile device 100 is not troublesome or is no longer troublesome, the process 550 may determine whether the current data rate is at the optimal level, step 557. If the data rate is not at the optimal data rate, then the base station 112 may restore the data rate to the optimal level by sending to the mobile device 100 a new data rate using the CDMA signaling channel, step 558. For example, the new data rate may be set to double the current data rate. Whether or not the data rate was changed, the process 550 may wait briefly, step 559, before repeating.

A database of troublesome locations, which may be maintained at the switching center 113, for example, may be generated and updated based on information regarding locations where calls are frequently dropped. Of course, a mobile device 100 cannot immediately transmit a current location to a switching center 113 after the call has been dropped. However, periodically or just before dropping a connection, the base station 112 involved may request the mobile device 111 to return a current location to the base station 112. Alternatively, a mobile device 111 with a built-in GPS receiver may determine the location at which a marginal call was dropped and then transmit the coordinates of the troublesome location to the switching center 113 when communication is reestablished. In a further embodiment, mobile devices 111 may periodically report their positions, allowing the base station 112 or switching center 113 to locate a troublesome location based upon the last reported location of the mobile device 111 prior to a dropped call. By collecting such information from all mobile devices 111 using a network, a network processor can rapidly build up a database of troublesome locations without the need to conduct dedicated surveys. By collecting such information 24 hours per day, a data base can be created to enable the system to recognize and anticipate changes in communication characteristics that occur throughout the day, such as interference from increased usage during rush hours, changes in thermal noise at various times of day and throughout the year, and varying transmissions from sources.

Alternative embodiments may determine whether the mobile device 111 is in a troublesome location based upon information determined from the current communication link. Software stored in the memory unit 192 of the mobile device 111 may determine whether the mobile device 111 is entering a troublesome location based upon signal quality, changes in bit error rate, etc. For example, the software stored in memory 192 and processed by the microprocessor 191 may analyze characteristics of the received communication signal such as a low Ec/Io, a very low radio signal strength indication, or transmit power reaching its maximum limit. The microprocessor 191 may also monitor bit error rates, particularly when transmit power is at maximum, to determine if error rates are approaching a value that could lead to a dropped call. Other embodiments may utilize software stored in memory 192 and processed by microprocessor 191 to extrapolate vector headings of the mobile device 111 based on its past movement. By determine its direction of travel, a microprocessor 191 can compare projected future locations to the database of known trouble spots. If it appears that the mobile device 111 is heading into a known troublesome location, proactive measures may be implemented to prevent dropped calls such as reducing the data transmission rate as described above before the communication link degrades. If the movement of the mobile device 111 indicates that the vector heading has been corrected to avoid a troublesome location or to a location with better reception, then measures may be taken to improve call quality by increasing the data rate.

In addition, if it appears that the mobile device 111 is either currently in or heading into a known troublesome location, the user can be alerted that a voice or data call may suffer degraded quality of service, fail to connect or be dropped if connected. So alerted, the user may postpone initiating a new call, thereby avoiding a dropped call situation. Alternatively, the mobile device 111 may automatically delay the initiation of any voice/data call attempts when the mobile device 111 is either currently in or heading into a known troublesome location. By doing so, the mobile device 111 may be able to conserve battery power by preventing futile call attempts.

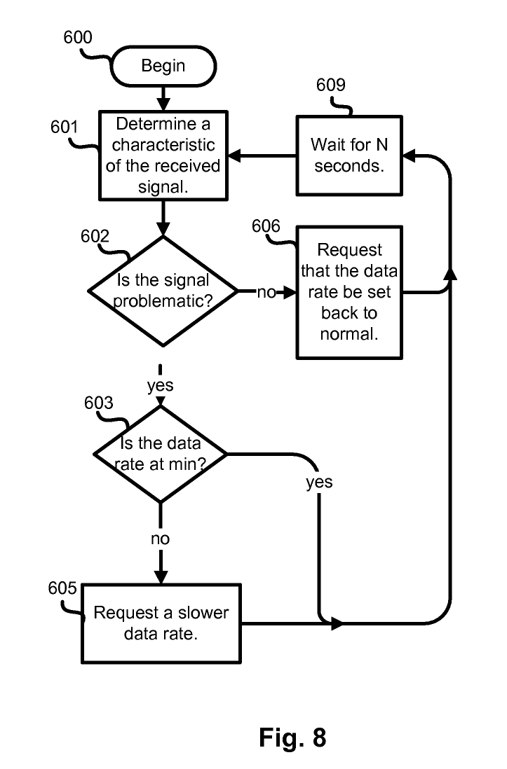

FIG. 8 illustrates an embodiment method which proactively adjusts transmission signal characteristics when a troublesome location is recognized based on some received signal characteristic. The process 600 begins by measuring, computing, or estimating a characteristic of the signal received by the mobile device 111, step 601. For example, the characteristic may be an approximation of the signal-to-noise ratio, such as Ec/I₀ or Ec/(I₀-Ec), as described above with reference to FIG. 4A. As another example, the characteristic may simply be the amplitude of the pilot signal Ec, where the noise may be assumed to be thermal noise with a value of −113 dBm in a 1.25 MHz bandwidth. As further example, the characteristic may be an estimate of the total amplitude of pilot pollution or the bit error rate of the received N-bit sequence 401. If the total power of polluting pilots or the error rate deviates outside a prescribed range, the received signal may be deemed problematic. Other methods of estimating a characteristic of the received signal by mobile device 111 may be possible.

The process 600 continues by determining whether the measured, computed, or estimated characteristic is problematic, such as below some threshold (or above the threshold for error rate or pilot pollution amplitude), step 602. There may be more than one determined signal characteristic with a corresponding threshold for each characteristic. If any one characteristic exceeds the corresponding threshold, the received signal may be deemed as troublesome.

If the received signal is deemed troublesome, the process 600 continues by determining whether the effective data rate is already at a specified minimum value, step 603. As discussed above, for voice transmissions, the minimum effective data rate may be the vocoder sampling rate, and for data transmissions, the minimum value may be 1200 bits per second. If the data rate is not already at the minimum value, then the mobile device 111 requests a slower data rate, step 605. In an alternative embodiment, the service provider network 114, not the mobile device 111, may determine the minimum data rate. For example, the base station 112 may direct the mobile device 100 to use a slower data rate that is one-half of the normal data rate.

In a CDMA mobile device 111, the data rate is set by the base station 112, not by the mobile device 111. The base station 112 may transmit a new data rate using the CDMA signaling channel in response to a request by the mobile device 111. A request for a slower data rate is not part of the CDMA standard specification, so a new standardized or proprietary code for this request may be required to implement this embodiment. Whether or not the mobile device 111 requested a slower data rate, the process 600 continues by waiting for a brief period of time, step 609, before repeating

If the process 600 determined that the characteristic of the mobile device is not problematic, then the process 600 may request that the data rate be reset back to the normal data rate, step 606. Thereafter, the process 600 waits for a brief period of time, step 609, before repeating with the process 600 continuing indefinitely or until the active connection with the mobile device 111 is terminated. This embodiment process 600 provides only two data rates: a normal data rate and a slower rate.

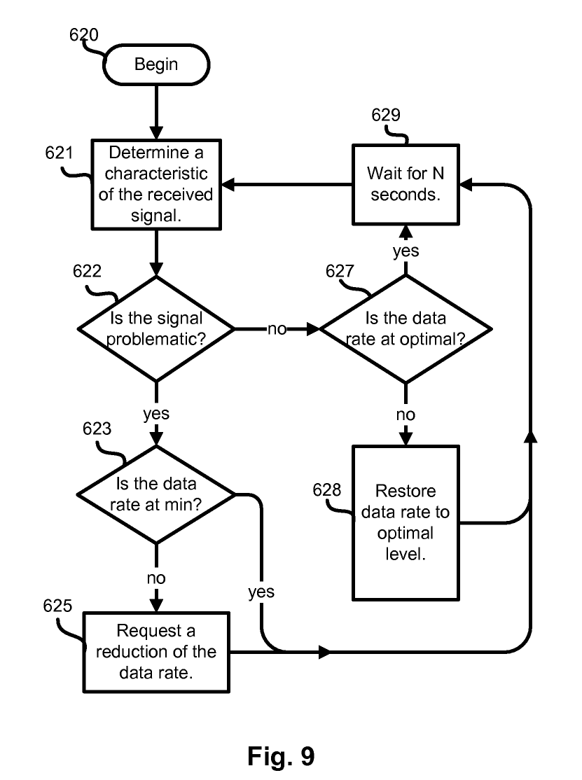

Another embodiment is illustrated in FIG. 9, which illustrates a process 620 allowing for more than two data rates. The process 620 begins by determining a characteristic of the signal received by the mobile device 100, step 621, which may be accomplished using any of the methods described above with reference to FIG. 8. The process 620 continues by determining whether the determined characteristic indicates a problematic signal, step 622, which may be accomplished by determining whether the determined characteristic is outside a prescribed range. If the signal is problematic, the process 620 determines whether the data rate is already at a specified minimum value, step 623. If not, a request is sent from the mobile device 111 to the base station 112 to decrease the data rate. In response, the base station 112 may direct the mobile device 111 to use a data rate that is one-half of the current data rate, for example, where the current data rate may already be slower than the normal data rate. Whether or not the mobile device 111 requested a slower data rate, the process 620 continues by waiting for a brief period of time, step 629, before repeating.

If the process 620 determined that the signal received by the mobile device is not problematic, then the process 620 tests whether the data rate is at its optimal level, step 627. If not, the process 620 may request that the data rate be restored to the optimal level, step 628. Thereafter, the process 620 waits for a brief period of time, step 629, before repeating.

The processes 600, 620 illustrated in FIGS. 8 and 9 may be executed on the mobile device 111 but the base station 112 may infer whether the data rate should be reduced or increased. The forgoing methods may be implemented in software operating on a processor in the mobile device 111, in a network processor, such as in the base station 112 or switching center, or implemented across the system with some steps implemented on the processor within the mobile device 111 and some steps implemented on a processor within the network. Since the mobile device 111 can measure the signal strength at its location, it may report the signal characteristics to a network processor to enable the network processor to accomplish the above methods.

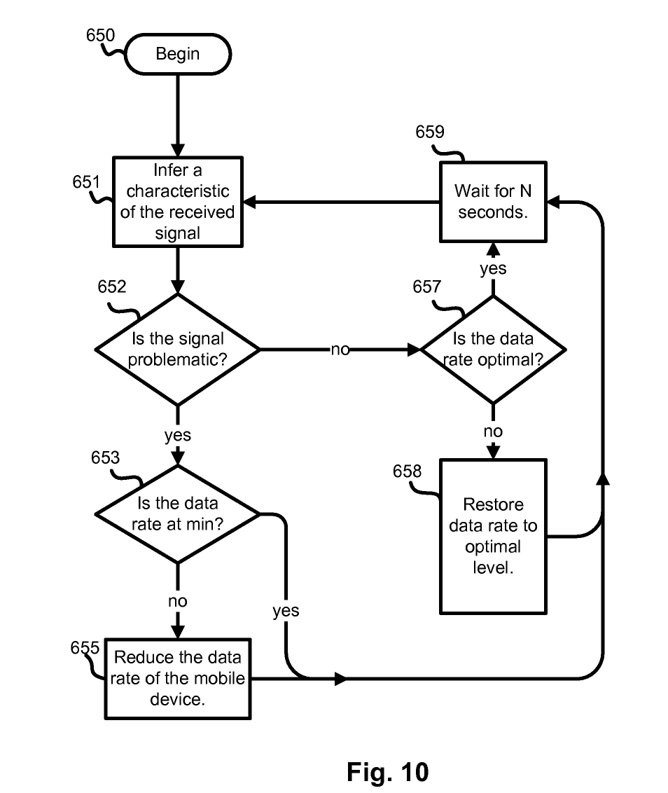

FIG. 10 illustrates an alternative process 650 that may be executed by the base station 112 to which the mobile device 111 is linked. The process 650 begins by indirectly determining a characteristic of the signal received by the mobile device 111. In one embodiment, the base station 112 may track whether the signal received from the mobile device 111 remains too low in spite of repeated attempts to increase the transmit power of the mobile device 111. That is, the signal transmitted by the mobile device 100 as received at the base station 112 may remain below the desired amplitude in spite of repeated attempts to increase the transmit power of the mobile device 111. In that case, base station 112 may infer that the mobile device 111 is also experiencing some problematic reception. The cause of the problematic situation may not be clear from the point of view of the base station 112.

The base station 112 may also infer the signal characteristics at the mobile device 111 based upon error information. For example, the base station 112 may infer that reception is degrading based upon increasing requests from the mobile device 111 for data packet retransmission. Such requests are made when the mobile device 111 detects an error that cannot be corrected using the error correction information embedded in the signal. Alternatively, the base station 112 may monitor the number of error bits received in transmissions from the mobile device 111. In yet another alternative, a base station 112 may send a test signal to the mobile device 111 requesting that the test signal be sent back. By analyzing the received test signal, the base station 112 can measure the bit error rate in the communication round trip. In The base station 112 may also request the mobile device 111 to send a test signal comprising a known pattern of bits which can be analyzed to determine the bit error rate in the path from the mobile device 111 to the base station 112. By subtracting the bit error rate in the device-to-station path from the round-trip path, an estimate of the station-to-device bit error rate can be obtained.

The cause may be a troublesome location rather than pilot pollution, for example. In such situations the effective data rates of both the forward and reverse signals may be reduced.

The process 650 determines whether the mobile device 111 appears to be experiencing a problematic situation, step 652. If so, the process 650 determines whether the data rate is already at a specified minimum data rate, step 653. If not, the base station 112 may reduce the data rate by sending to the mobile device 111 a new data rate using the CDMA signaling channel, step 655. For example, the data rate may be set to one-half the current data rate. Whether or not the data rate was reduced, the process 650 continues by waiting for a brief period, step 659, before repeating.

If the mobile device 111 not longer seems to be experiencing a problematic signal, such as because the base station 112 is not receiving a problematic signal, the process 650 may determine whether the data rate is at the optimal level, step 657. If the data rate is not at the optimal data rate, then the base station 112 may restore the data rate to the optimal level by sending to the mobile device 111 a new data rate using the CDMA signaling channel, step 658. For example, the new data rate may be set to double the current data rate. Whether or not the data rate was changed, the process 650 may wait briefly, step 659, before repeating.

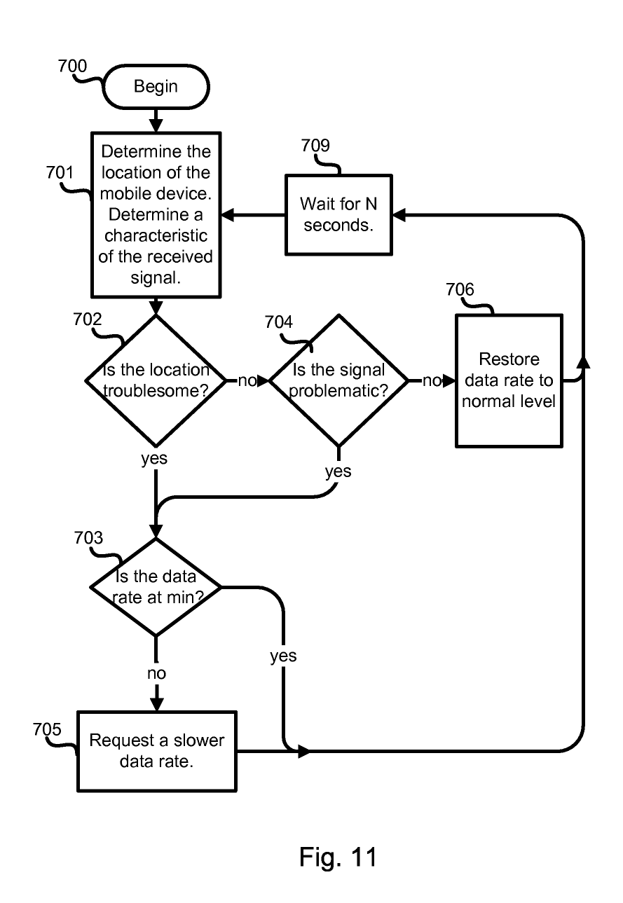

Alternative embodiments may decrease or increase the data rate of the mobile device 111 based on both the location of the mobile device 111 and on at least one characteristic of the received signal. Such an embodiment is illustrated in FIG. 11 in which a process 700 begins by determining the location of the mobile device 100 and determining at least one characteristic of the signal received by the mobile device 111, step 701. Any of the methods of determining the location and signal characteristics previously discussed with reference to FIGS. 5 and 8 may be employed in this step.

The process 700 continues by determining whether the location is known to be troublesome, step 702, and whether the signal characteristic is problematic, step 704. If the location is troublesome and/or if the signal characteristic is problematic, the process 700 determines whether the effective data rate is already at a specified minimum value, step 703. As described above, for voice transmissions, the effective data rate is the vocoder sampling rate, while data transmissions may have a minimum value of 1200 bits per second. If the data rate is not already at the minimum value, then the mobile device 111 requests a slower data rate, step 705. In an alternative embodiment, the service provider network 114, not the mobile device 111, may determine the minimum data rate. For example, the base station 112 may direct the mobile device 111 to use a slower data rate that is one-half of the normal data rate, for example. Whether or not the mobile device 111 requested a slower data rate, the process 700 continues by waiting for a brief period of time, such as several seconds, step 709, before repeating.

If the process 700 determined that the location of the mobile device is not known to be troublesome and the signal characteristic is not problematic, then the process 700 may request that the data rate be reset to the normal data rate, step 706. Thereafter, the process 700 waits for a brief period of time, step 709, before repeating. This process 700 provides only two data rates: a normal data rate and a slower rate.

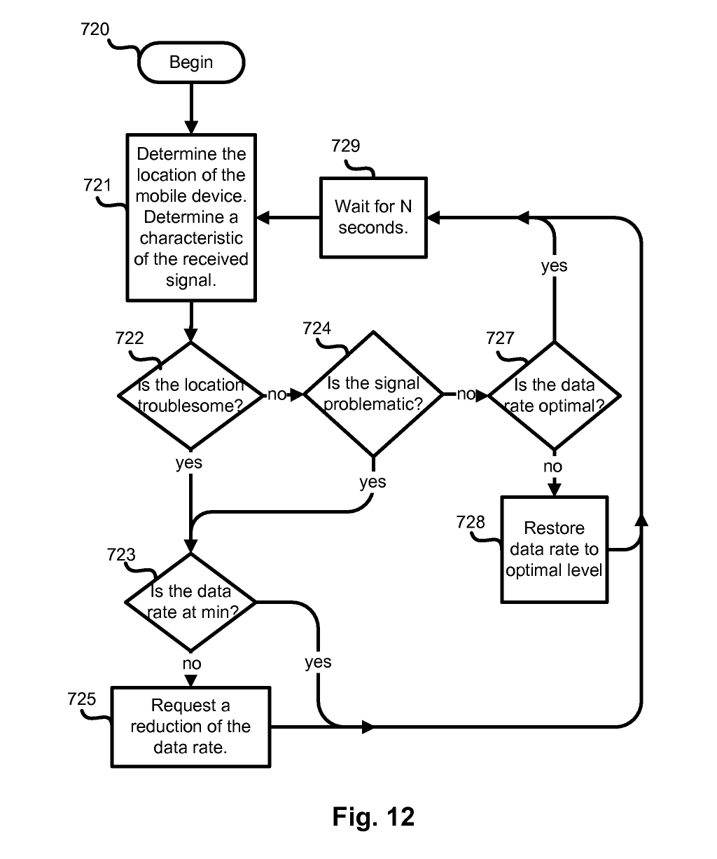

An alternative embodiment illustrated in FIG. 12, process 720, allows for more than two data rates. This process 720 begins by determining the location of the mobile device 100 and at least one characteristic of the signal received by the mobile device 100, step 721. Determining the location and signal characteristics may be accomplished using any of the methods described above in reference to FIGS. 5 and 8.

The process 720 continues by determining whether the location is known to be troublesome, step 722, and whether the signal characteristic is problematic, step 724. If the location is known to be troublesome or if the signal is problematic, the process 720 determines whether the data rate is already at a specified minimum value, step 723. If not, a request is sent from the mobile device 111 to the base station 112 to decrease the data rate. In response, the base station 112 may direct the mobile device 111 to use a data rate that is one-half of the current data rate, for example, where the current data rate may already be slower than the normal data rate. Whether or not the mobile device 111 requested a slower data rate, the process 720 continues by waiting for a brief period of time, such as a few seconds, step 729, before repeating.

If the process 720 determined that the location of the mobile device 111 is not know to be troublesome and the signal received by the mobile device is not problematic, the process 720 tests whether the data rate is at a specified optimal level, step 727. If not, the process 720 may request that the data rate be restored to the optimal level, step 728. Thereafter, the process 720 waits for a brief period of time, step 729, before repeating.

The processes 700, 720 illustrated in FIGS. 11 and 12 may be executed on the mobile device 100, but the base station 112 may indirectly infer whether the data rate should be reduced or increased. The forgoing methods may be implemented in software operating on a processor in the mobile device 111, in a network processor, such as in the base station 112 or switching center, or implemented across the system with some steps implemented on the processor within the mobile device 111 and some steps implemented on a processor within the network. Since the mobile device 111 can measure the signal strength at its location, it may report the signal characteristics to a network processor to enable the network processor to accomplish the above methods.

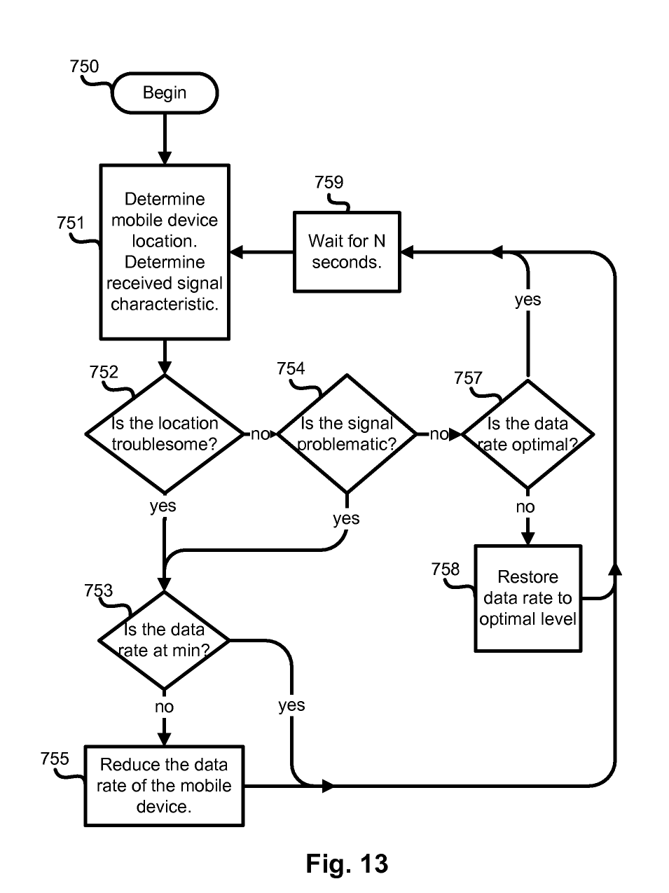

FIG. 13 illustrates an alternative process 750 that may be executed by the base station 112 to which the mobile device 111 is connected. The process 750 begins by determining the location of the mobile device 111 and by indirectly determining a characteristic of the signal received by the mobile device 111. Determining the location and determining the signal characteristics may be accomplished using any of the methods described above with reference to FIGS. 7 and 10.

The process 750 determines whether the mobile device 111 is in a known troublesome location, step 52 or whether the mobile device 111 appears to be experiencing a problematic signal, step 754. The mobile device 111 may be experiencing the reception of a problematic forward signal if, the base station 112 is experiencing the reception of a problematic reverse signal. If so, the process 750 determines whether the data rate is already at a specified minimum data rate, step 753. If not, the base station 112 may reduce the data rate by sending to the mobile device 100 a new data rate using the CDMA signaling channel, step 755. For example, the data rate may be set to one-half the current data rate. Whether or not the data rate was reduced, the process 750 continues by waiting for a brief period, step 759, before repeating.

If the mobile device 111 no longer seems to be in a troublesome location and does not seem to have problematic signal, the process 750 may determine whether it the data rate is at an optimal level, step 757. If the data rate is not at a specified optimal data rate, then the base station 112 may restore the data rate to an optimal level by sending to the mobile device 111 a new data rate using the CDMA signaling channel, step 758. For example, the new data rate may be set to double the current data rate. Whether or not the data rate was changed, the process 750 may wait briefly, step 759, before repeating.

The various methods discussed above utilize the relationship of data rate and SNR to proactively take actions to improve the SNR of a call. Other well known methods of improving SNR or reducing bit error rates may be implemented. Moreover, various combinations of the well known methods may be implemented. For example, various error correction and Hamming codes may be utilized which improve SNR. Forward error correction (FEC) is a well known method for detecting and correcting errors in data transmission, whereby the sender adds additional data to its message which allows the receiver to detect and correct errors (within some bound) without the need to ask the sender retransmit garbled data. The advantage of FEC is that retransmission of data packets can often be avoided, although it comes at the cost of adding data to the data to be transmitted. Hamming codes and other error correcting codes add parity bits to the data stream to enable a receiver to detect and correct bit errors in a transmission signal. The use of various error detection and correction codes slow the effective payload data rate even though data is being transmitted and received at the same rate. Because a number of the transmitted bits per second are used for error detection and correction, the total number of actual payload data bits that are transmitted in a given period of time is decreased. Thus, to include FEC coding in order to reduce errors in transmitted data, either the bandwidth of the transmission channel must be increased or more forward error correction information must be included within the data transmission. By using a more robust error detection and correction code, overall SNR is improved in an effect referred to as “coding gain.”

Other methods to improve SNR may include interleaving. Interleaving is used in digital data transmission technology to protect the data transmission against burst errors. Burst errors are momentary interference (increased noise) or dropped signal (reduced signal) which result in the loss of a few bits in a data transmission stream. Burst errors may be caused by brief but intense emissions, such as lightning, or brief but deep signal reductions, such as destructive interference due to multipath interference. Such burst errors may affect mobile device communication when the mobile device 111 is rapidly moving through a troublesome location, such as locations where signals from base stations follow multiple paths. While a relatively large number of bits in a row may be lost in a single burst, the rest of the transmitted data may be unaffected. However, a burst can wipe out more bits, such as an entire byte of data, within a block of data than can be corrected using FEC. Interleaving is used to enable FEC encoded data to withstand burst errors and still be able to recover data. Since burst errors are short time events, a number of data blocks (codewords) are interleaved so their respective bits are transmitted over a long period of time. That way, a burst error will only impact a correctable number of bits within each codeword, leaving the decoder able decode the codewords correctly. The problem with interleaving is that it delays delivery of each data element or codeword, an effect known as “latency.” In other words, when data is interleaved it takes some time to receive all the bits associated with a particular codeword before the codeword can be assembled and decoded.

Any of a variety of methods known to those of skill in the art to improve SNR can be utilized in the invention. Moreover, a combination of methods to improve SNR may be implemented. As the mobile device 111 is determined to be in or approaching a troublesome location, a request by the microprocessor 191 may be made to alter the various characteristics of the transmitted signal so as to improve SNR. For example, the microprocessor 191 may send a message to the base station 112 requesting a change in data rate and/or change in the type or depth of FEC and interleaving. Since the base station 112 receiver must be configured to receive and decode transmissions from the mobile device 111, the change in data rate and error encoding must be negotiated and coordinated with the base station 112 before the changes are implemented. Then in conjunction with implementation on the base station, microprocessor 191 may instruct the transmitter 198 to reduce the data rate, utilize a more robust error detection code, implement a more robust interleaving scheme, or a combination of these methods. A similar negotiation and transmitter/receiver configuration is required for the station-to-device communication link, and similar methods may be implemented on both links simultaneously.

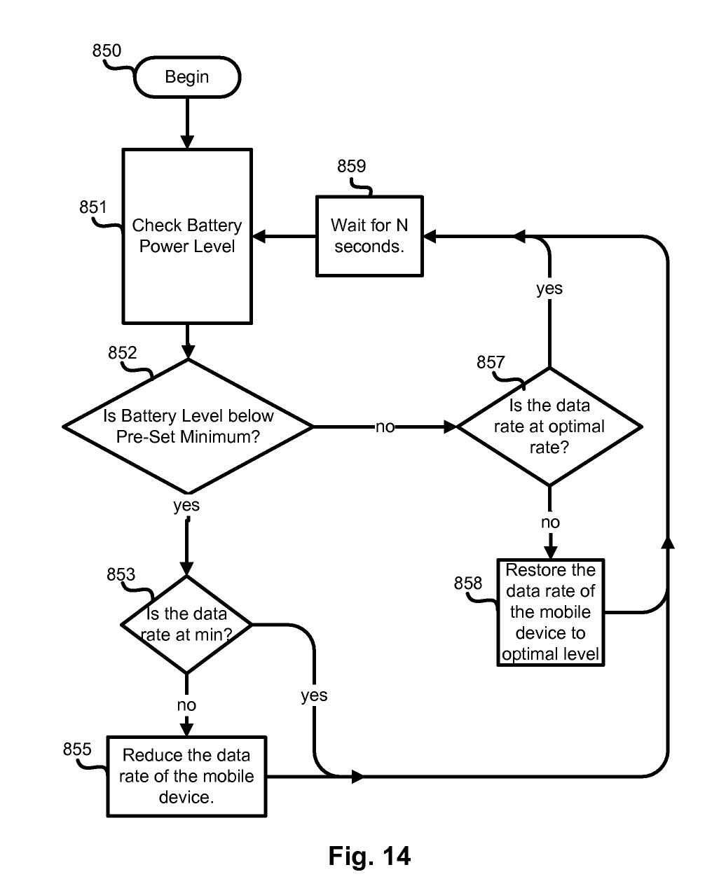

FIG. 14 illustrates a power save embodiment method 850 that may be executed by the mobile device 111. In order to extend the amount of time a mobile device 111 can operate without re-charging, the mobile device 111 can take a number of proactive steps to efficiently utilize the available power supplied by the battery. The process 850 begins by monitoring the power level of the battery of the mobile device 111, step 851. The process 850 determines whether the power level of the battery powering the mobile device 111 has fallen below a pre-set minimum value, step 852. If the battery power level has fallen below a pre-set minimum, the process 850 determines whether the data rate is already at a specified minimum data rate, step 853. If the mobile device 111 is not already at the specified minimum data rate, the mobile device 111 processor 191 may reduce the data rate by sending to the base station 112 a new data rate request using the CDMA signaling channel, step 855. For example, the data rate may be set to one-half the current data rate. Whether or not the data rate was reduced, the process 850 continues by waiting for a brief period, step 959, before repeating.

If the mobile device 111 battery is no longer below a pre-set power level, such as when the mobile device 111 is being charged, the process 850 may determine whether the data rate is at an optimal level, step 857. If the data rate is not at a target or specified optimal data rate, then the mobile device 111 processor 191 may restore the data rate to an optimal level by sending to the base station 112 a new data rate request using the CDMA signaling channel, step 858. For example, the new data rate may be set to double the current data rate. Whether or not the data rate was changed, the process 850 may wait briefly, step 859, before repeating. In this manner, the mobile device 111 can reduce data transmission rates to save power to transmit data when available power levels have fallen below a pre-set minimum thereby enabling data transmissions to continue longer on a depleted battery. While Quality of Service of the voice or data call may diminish due to the reduced data rate, acceptable quality of service levels may still be achieved.

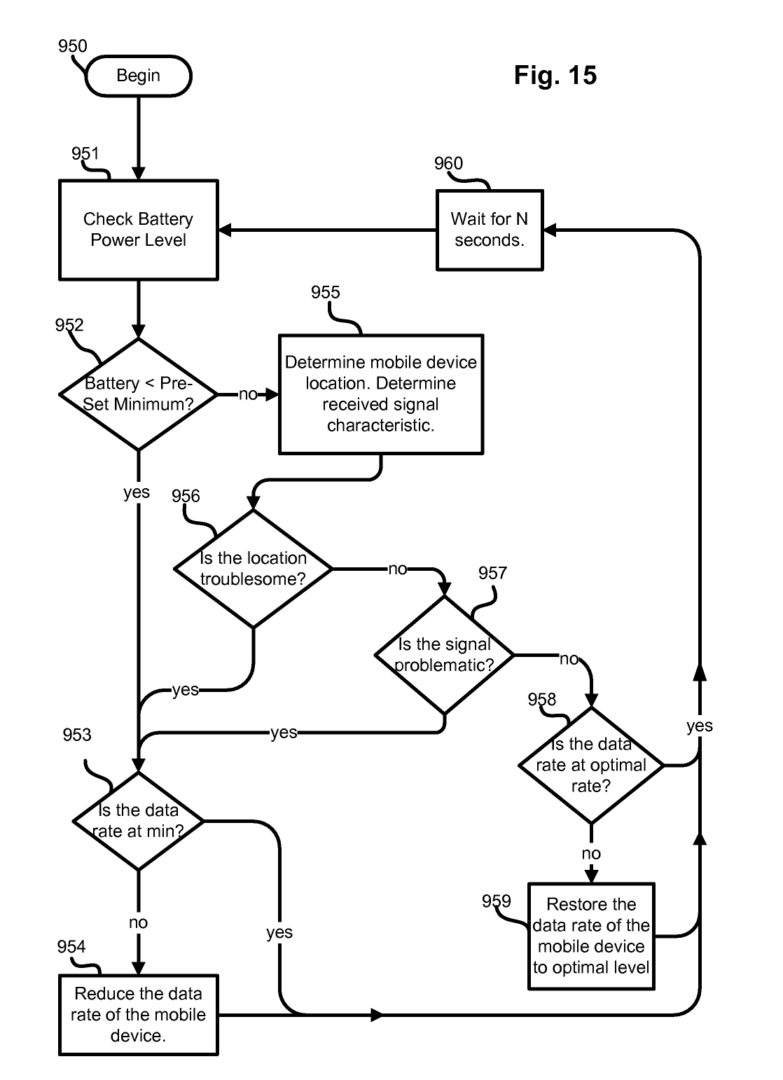

FIG. 15 illustrates a power save embodiment method 950 which incorporates the ability to improve QOS in trouble spots. The process 950 begins by monitoring the power level of the battery of the mobile device 111, step 951. The process 950 determines whether the power level of the battery powering the mobile device 111 has fallen below a pre-set minimum value, step 952. If the battery power level has fallen below a pre-set minimum, the process 950 determines whether the data rate is already at a specified minimum data rate, step 953. If the mobile device 111 is not already at the specified minimum data rate, the mobile device 111 processor 191 may reduce the data rate by sending to the base station 112 a new data rate request using the CDMA signaling channel, step 954. For example, the data rate may be set to one-half the current data rate. Whether or not the data rate was reduced, the process 950 continues by waiting for a brief period, step 960, before repeating.

In instances where the mobile device 111 battery is no longer below a pre-set power level, such as when the mobile device 111 is being charged but the mobile device 111 has moved into a trouble spot, there may be a need to reduce the data rate to improve QOS. In such instances, the process 950 may determine the location of the mobile device 111 and indirectly determine a characteristic of the signal received by the mobile device 111. Determining the location and determining the signal characteristics may be accomplished using any of the methods described above with reference to FIGS. 7, and/or 10-13.

The process 950 determines whether the mobile device 111 is in a known troublesome location and whether the mobile device 111 appears to be experiencing a problematic signal, step 955. For example, the mobile device 11 may enter a known trouble spot which may be detected by any of the aforementioned methods, step 956. In addition, the mobile device 111 may be experiencing the reception of a problematic forward signal if the base station 112 is experiencing the reception of a problematic reverse signal. Problematic signals may be detected using any of the aforementioned methods, step 957. As shown in FIG. 15, the embodiment process first determines whether the location is troublesome, step 956. If the location is not troublesome, the embodiment process next determines if the signal is problematic, step 957. One skilled in the art would appreciate that an embodiment may determine whether a signal is problematic first, then determine whether a location is troublesome.

If the process 950 determines that either the mobile device 11 is in a trouble spot or the signal is problematic, the process determines whether the data rate is already at a specified minimum data rate, step 953. If the data rate is not at a specified minimum, the base station 112 may reduce the data rate by sending to the mobile device 111 a new data rate using the CDMA signaling channel, step 954. For example, the data rate may be set to one-half the current data rate. Whether or not the data rate was reduced, the process 950 continues by waiting for a brief period, step 960, before repeating.

If the mobile device 111 neither in a troublesome location nor suffers from a problematic signal, the process 950 may determine whether it the data rate is at an optimal level, step 958. If the data rate is not at a specified optimal data rate, then the base station 112 may restore the data rate to an optimal level by sending to the mobile device 111 a new data rate using the CDMA signaling channel, step 959. For example, the new data rate may be set to double the current data rate. Whether or not the data rate was changed, the process 950 may wait briefly, step 960, before repeating.

Although the methods described herein are applicable to a CDMA air interface, the methods may also be applicable to other cellular standards, such as GSM, cdma2000, UTMS, W-CDMA, Wi-Fi, Bluetooth, Zigbee, and others.

The hardware used to implement the forgoing embodiments may be processing elements and memory elements configured to execute a set of instructions, wherein the set of instructions are for performing method steps corresponding to the above methods. Alternatively, some steps or methods may be performed by circuitry that is specific to a given function.

Those of ordinary skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware, firmware, or software depends upon the particular application and design constraints imposed on the overall system. Those of ordinary skill in the art may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile device are intended to encompass any one or all memory modules within the mobile device without limitation to a particular configuration, type, or packaging. An exemplary storage medium is coupled to a processor in the mobile device such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for maintaining call quality between a mobile device and a wireless network, comprising:
determining whether an active communication connection between the mobile device and wireless network is troublesome; and reducing a rate at which data is transmitted over the active connection to or from the mobile device when the active connection is troublesome.

2. The method of claim 1, wherein determining whether the active connection between the mobile device and wireless network is troublesome comprises determining a current location of the mobile device and comparing the current location of the mobile device to a data base of known troublesome locations.

3. The method of claim 1, wherein determining whether the active connection between the mobile device and wireless network is troublesome comprises estimating a signal-to-noise ratio and determining whether the estimated signal-to-noise ratio is below a prescribed minimum.

4. The method of claim 1, wherein determining whether the active connection between the mobile device and wireless network is troublesome comprises determining an error rate and determining whether the error rate exceeds a prescribed maximum.

5. The method of claim 1, wherein determining whether the active connection between the mobile device and wireless network is troublesome comprises determining a vector of movement of the mobile device and extrapolating an expected location of the mobile device and comparing the extrapolated location of the mobile device to a database of known troublesome locations.

6. The method of claim 1, wherein reducing the data transmission rate is accomplished by using a more robust error detection and correction coding scheme.

7. The method of claim 6, wherein reducing the data transmission rate is accomplished by further using a more robust interleaving scheme.

8. The method of claim 1, wherein reducing the data transmission rate is accomplished by using a combination of reduced data rate, more robust error detection and correction coding scheme, and more robust interleaving scheme.

9. The method of claim 1, further comprising:
determining whether the active connection between the mobile device and wireless network is no longer troublesome; and
increasing the data transmission rate when the active connection is no longer troublesome.

10. A mobile device comprising:
a processor; and
a memory unit coupled to the processor, wherein the memory contains processor readable software instructions to:
determine whether an active connection between the mobile device and wireless network is troublesome;
reducing a rate at which data is transmitted over the active connection to or from the mobile device when the active connection is troublesome;
a transmitter for transmitting the reduced data rate criteria to a base station receiver; and
a receiver for receiving the reduced data rate criteria from the base station receiver.

11. The mobile device of claim 10, further wherein the memory contains processor readable software instructions to determine a current location of the mobile device and compare the current location of the mobile device to a database of known troublesome locations stored in the memory.

12. The mobile device of claim 10, further wherein the memory contains processor readable software instructions to estimate a signal-to-noise ratio of the communication signal received by the mobile device and determine whether the estimated signal-to-noise ratio is below a prescribed minimum.

13. The mobile device of claim 10, further wherein the memory contains processor readable software instructions to determine an error rate of the communication signal received by the mobile device and to determine whether the error rate exceeds a prescribed maximum.

14. The mobile device of claim 10, further wherein the memory contains processor readable software instructions to determine a vector of movement of the mobile device and extrapolate an expected location of the mobile device and compare the extrapolated location of the mobile device to a database of known troublesome locations stored in the memory.

15. The mobile device of claim 10, further wherein the memory contains processor readable software instructions to reduce the rate at which data is transmitted over the active connection to or from the mobile device when the active connection is troublesome by using a more robust error detection and correction coding scheme for the communication signal.

16. The mobile device of claim 15, further wherein the memory contains processor readable software instructions to reduce the rate at which data is transmitted over the active connection to or from the mobile device when the active connection is troublesome by further using a more robust interleaving scheme for the communication signal.

17. The mobile device of claim 10, further wherein the memory contains processor readable software instructions to reduce the rate at which data is transmitted over the active connection to or from the mobile device when the active connection is troublesome by using any of a combination of reduced data rate, more robust error detection and correction coding scheme, and more robust interleaving scheme for the communication signal.

18. The mobile device of claim 10, further wherein the memory contains processor readable software instructions to
determine whether the active connection between the mobile device and wireless network is no longer troublesome; and
increase the data transmission rate when the active connection is no longer troublesome.

19. The mobile device of claim 11 further comprising a GPS receiver.

20. The mobile device of claim 11 further comprising an AGPS receiver.

21. The mobile device of claim 10 further wherein the receiver is capable of determining a characteristic of a received signal; and
the transmitter is capable of altering its transmitted data rate, error coding scheme and interleaving scheme.

22. A mobile device comprising:
means for determining whether an active connection between the mobile device and wireless network is troublesome;
means for reducing a rate at which data is transmitted over the active connection to or from the mobile device when the active connection is troublesome.

23. The mobile device of claim 22, further comprising means for determining a current location of the mobile device and comparing the current location of the mobile device to a database of known troublesome locations.

24. The mobile device of claim 22, further comprising means for estimating a signal-to-noise ratio and determining whether the estimated signal-to-noise ratio is below a prescribed minimum.

25. The mobile device of claim 22, further comprising means for determining an error rate and determining whether the error rate exceeds a prescribed maximum.

26. The mobile device of claim 22, further comprising means for determining a vector of movement of the mobile device and means for extrapolating an expected location of the mobile device and means for comparing the extrapolated location of the mobile device to a database of known troublesome locations.

27. The mobile device of claim 22, further comprising means for implementing a more robust error detection and correction coding scheme for the communication signal.

28. The mobile device of claim 27, further comprising means for implementing a more robust interleaving scheme for the communication signal.

29. The mobile device of claim 22, further comprising means for implementing any of a combination of reduced data rate, more robust error detection and correction coding scheme, and more robust interleaving scheme for the communication signal.

30. The mobile device of claim 22, further comprising
means for determining whether the active connection between the mobile device and wireless network is no longer troublesome; and
means for increasing the data transmission rate when the active connection is no longer troublesome.

31. A processor coupled to a wireless network for managing a plurality of voice and data calls from a plurality of mobile devices on a base station comprising:
a transmitter for transmitting altered transmission characteristic settings of a communication signal between one of the plurality of mobile devices and the base station; and
a receiver for receiving altered transmission characteristic settings of the communication signal between one of the plurality of mobile devices and the base station; and
a memory unit coupled to the processor, wherein the memory contains processor readable software instructions to:
determine whether an active connection between one of the plurality of mobile devices and base station is troublesome;
reducing a rate at which data is transmitted over the active connection to or from the mobile device when the active connection is troublesome.

32. The processor of claim 31, further wherein the memory contains processor readable software instructions to determine a current location of the one of the plurality of mobile devices and compare the current location of the one of the plurality of mobile devices to a database of known troublesome locations stored in the memory.

33. The processor of claim 31, further wherein the memory contains processor readable software instructions to estimate a signal-to-noise ratio of the communication signal received from the one of the plurality of mobile devices and determine whether the estimated signal-to-noise ratio is below a prescribed minimum stored in the memory.

34. The processor of claim 31, further wherein the memory contains processor readable software instructions to determine an error rate of the communication signal received from the one of the plurality of mobile devices and determine whether the error rate exceeds a prescribed maximum.

35. The processor of claim 31, further wherein the memory contains processor readable software instructions to determine a vector of movement of the one of the plurality of mobile devices and extrapolate an expected location of the one of the plurality of mobile devices and compare the extrapolated location of the one of the plurality of mobile devices to a database of known troublesome locations stored in the memory.

36. The processor of claim 31, further wherein the memory contains processor readable software instructions to reduce the rate at which data is transmitted over the active connection to or from the mobile device when the active connection is troublesome by using a more robust error detection and correction coding scheme for the communication signal transmitted by the base station to the one of the plurality of mobile devices.

37. The processor of claim 36, further wherein the memory contains processor readable software instructions to reduce the rate at which data is transmitted over the active connection to or from the mobile device when the active connection is troublesome by further using a more robust interleaving scheme for the communication signal transmitted by the base station to the one of the plurality of mobile devices.

38. The processor of claim 31, further wherein the memory contains processor readable software instructions to reduce the rate at which data is transmitted over the active connection to or from the mobile device when the active connection is troublesome by using any of a combination of reduced data rate, more robust error detection and correction coding scheme, and more robust interleaving scheme for the communication signal transmitted by the base station to the one of the plurality of mobile devices.

39. The processor of claim 31, further wherein the memory contains processor readable software instructions to
determine whether the active connection between the one of the plurality of mobile devices and wireless network is no longer troublesome; and
increase the data transmission rate when the active connection is no longer troublesome.

40. A processor readable storage medium having stored thereon processor executable instructions configured to cause a processor to perform steps comprising:
determining whether an active connection between one of a plurality of mobile devices and a wireless network is troublesome;
reducing a rate at which data is transmitted over the active connection to or from the mobile device when the active connection is troublesome.

41. The processor executable instructions of claim 40 further configured to cause a processor to perform the steps of determining a current location of the one of the plurality of mobile devices and comparing the current location of the one of the plurality of mobile devices to a database of known troublesome locations.

42. The processor executable instructions of claim 40 further configured to cause a processor to perform the steps of estimating a signal-to-noise ratio of the communication signal transmitted and received by the one of the plurality of mobile devices and determining whether the estimated signal-to-noise ratio is below a prescribed minimum.

43. The processor executable instructions of claim 40 further configured to cause a processor to perform the steps of determining an error rate of the communication signal transmitted and received by the one of the plurality of mobile devices and determining whether the error rate exceeds a prescribed maximum.

44. The processor executable instructions of claim 40 further configured to cause a processor to perform the steps of determining a vector of movement of the one of the plurality of mobile devices and extrapolating an expected location of the one of the plurality of mobile devices and comparing the extrapolated location of the mobile device to a database of known troublesome locations.

45. The processor executable instructions of claim 40 further configured to cause a processor to perform the steps of implementing a more robust error detection and correction coding scheme for the communication signal transmitted from and received by the one of the plurality of mobile devices.

46. The processor executable instructions of claim 45 further configured to cause a processor to perform the steps of implementing a more interleaving scheme for the communication signal transmitted from and received by the one of the plurality of mobile devices.

47. The processor executable instructions of claim 40 further configured to cause a processor to perform the steps of implementing any of a combination of reduced data rate, more robust error detection and correction coding scheme, and more robust interleaving scheme for the communication signal transmitted from and received by the one of the plurality of mobile devices.

48. The processor executable instructions of claim 40 further configured to cause a processor to perform the steps of
determining whether the active connection between one of the plurality of mobile devices and wireless network is no longer troublesome;
increasing the data transmission rate when the active connection is no longer troublesome.

49. A method for conserving battery power in a mobile device, comprising:
determining whether the power level of the battery in the mobile device has decreased below a pre-set minimum level; and
reducing a rate at which data is transmitted over an active connection between the mobile device and a wireless network when the power level of the battery in the mobile device has decreased below the pre-set minimum level.

50. The method of claim 49, further comprising:
determining whether the power level of the battery in the mobile device is no longer below a pre-set minimum level; and
increasing the data transmission rate when the power level of the battery in the mobile device is no longer below a pre-set minimum level.

51. A mobile device comprising:
a processor; and
a memory unit coupled to the processor, wherein the memory contains processor readable software instructions to:
determine whether the power level of the battery in the mobile device has decreased below a pre-set minimum level;
reducing a rate at which data is transmitted over an active connection between the mobile device and a wireless network when the power level of the battery in the mobile device has decreased below the pre-set minimum level;
and
a transmitter for transmitting the reduced data rate criteria to a base station receiver.

52. The mobile device of claim 51, further wherein the memory contains processor readable software instructions to
determine whether the power level of the battery in the mobile device is no longer below a pre-set minimum level; and
increase the data transmission rate when the power level of the battery in the mobile device is no longer below a pre-set minimum level.

53. A processor readable storage medium having stored thereon processor executable instructions configured to cause a processor to perform steps comprising:
determining whether the power level of the battery in the mobile device has decreased below a pre-set minimum level; and
reducing a rate at which data is transmitted over an active connection between the mobile device and a wireless network when the power level of the battery in the mobile device has decreased below the pre-set minimum level.

54. The processor executable instructions of claim 53 further configured to cause a processor to perform the steps of:
determining whether the power level of the battery in the mobile device is no longer below a pre-set minimum level; and
increasing the data transmission rate when the power level of the battery in the mobile device is no longer below a pre-set minimum level.
